(19) United States
(12) Patent Application Publication
(10) Pub. No.: US 2002/0136940 A1
(43) Pub. Date: Sep. 26, 2002

(54) Decal method of making membrane electrode assemblies for fuel cells

(75) Inventors: Shane S. Mao, Woodbury, MN (US); Pinar E. Serim, Eagan, MN (US); Junkang J. Liu, Woodbury, MN (US); Edward M. Fischer, White Bear Lake, MN (US); David R. Mekala, Maplewood, MN (US)

Correspondence Address: Attention: Philip Y. Dahl, Office of Intellectual Property Counsel, 3M Innovative Properties Company, P.O. Box 33427, St. Paul, MN, 55133-3427, US

(73) Assignee: 3M Innovative Properties Company

(21) Appl. No.: 10/059,590

(22) Filed: Jan. 29, 2002

Related U.S. Application Data
(63) Continuation of application No. 60/264,913, filed on Jan. 29, 2001.

(51) Int. Cl. H01M 8/10; H01M 4/88; B05D 5/12

(52) U.S. Cl. 429/30; 502/101; 427/115

(57) ABSTRACT

The present invention provides a method of making 3-layer membrane electrode assemblies (MEAs) involving a direct transfer of the catalyst to the polymer electrolyte membrane as a decal in protonated form (acid form) at low temperature, particularly by use of a microstructured transfer medium or a flame-treated silicone-containing transfer medium.

### CROSS REFERENCE TO RELATED APPLICATION

This application claims priority to U.S. Provisional Patent Application No. 60/264,913, filed Jan. 29, 2001.

### FIELD OF THE INVENTION

This invention relates to a process of making 3-layer membrane electrode assemblies (MEAs) involving a direct transfer of the electrode to the polymer electrolyte membrane as a decal. The MEA prepared from this process exhibited improved fuel cell performance and good reproducibility.

### BACKGROUND OF THE INVENTION

U.S. Pat. Nos. 5,211,984 and 5,234,777 disclose decal methods of making 3-layer membrane electrode assemblies (MEAs). These patents describe methods which make use of ionomers in thermoplastic form or in salt form or “Na⁺ form”.

### SUMMARY OF THE INVENTION

Briefly, the present invention provides a method of making 3-layer membrane electrode assemblies (MEAs) involving a direct transfer of the catalyst to the polymer electrolyte membrane as a decal in protonated form at low temperature.

In another aspect, the present invention provides a method of making 3-layer membrane electrode assemblies (MEAs) involving a direct transfer of the catalyst to the polymer electrolyte membrane as a decal from a microstructured release transfer medium. The microstructures in the release transfer medium are typically generated in a regular pattern by microreplication or in a random pattern by flame treatment or a suitable medium.

It is an advantage of the present invention to provide a simplified yet reliable process of making a three-layer MEA that is more easily scaled to high production levels than known processes.

### BRIEF DESCRIPTION OF THE DRAWING

FIG. 1 is an optical micrograph of a 3 Layer MEA according to the present invention.

FIG. 2 is a scanning electron micrograph of a 3 Layer MEA according to the present invention.

FIG. 3 is a scanning electron micrograph of a 3 Layer MEA according to the present invention.

FIG. 4 is a graph of polarization curves for four MEAs: Curve 1 is a comparative MEA having a loading of 0.20 mg Pt/cm² while curves 2-4 are MEAs made according to the present invention having loadings of 0.11 mg Pt/cm² for curve 2, 0.17 mg Pt/cm² for curve 3, and 0.35 mg Pt/cm² for curve 3.

### DETAILED DESCRIPTION OF PREFERRED EMBODIMENTS

This invention relates to an improved process of making 3-layer membrane electrode assemblies (MEAs). A membrane electrode assembly (MEA) is the central element of proton exchange membrane fuel cells. Fuel cells are electrochemical cells which produce usable electricity by the catalyzed combination of a fuel such as hydrogen and an oxidant such as oxygen. Typical MEAs comprise an ion conductive membrane (ICM) or polymer electrolyte membrane (PEM), which functions as a solid electrolyte, in contact with electrode layers that include electrochemical catalysts such as platinum. Gas diffusion layers (GDLs) in contact with the catalyzed faces of the MEA facilitate the gas transport and collect current. In a typical PEM fuel cell, protons are formed at the anode via hydrogen oxidation and transported to the cathode to react with oxygen, allowing electrical current to flow in an external circuit connecting the electrodes.

The method according to the present invention involves the application of the catalyst as a decal, preferably onto the ICM. An electrode decal can be formed by coating or painting the ink on a release medium. Transfer of the electrode decals onto an ICM forms a 3-layer MEA.

Any suitable ICM may be used. The ICM typically has a thickness of less than 50 μm, more typically less than 40 μm, more typically less than 30 μm, and most typically about 25 μm. The ICM is typically comprised of a polymer electrolyte that is an acid-functional fluoropolymer, such as Nafion® (DuPont Chemicals, Wilmington Del.) and Flemion™ (Asahi Glass Co. Ltd., Tokyo, Japan). The polymer electrolytes useful in the present invention are typically preferably copolymers of tetrafluoroethylene and one or more fluorinated, acid-functional comonomers. Typically the polymer electrolyte bears sulfonate functional groups. Most typically the polymer electrolyte is Nafion. The polymer electrolyte typically has an acid equivalent weight of 1200 or less, more typically 1100 or less, more typically 1050 or less, and most typically about 1000. In a method according to the present invention, the ICM may be used in the decal process in its acidified form, i.e., without conversion to a salt, and at low temperature, i.e., less than 120° C., more typically less than 100° C., more typically less than 90° C., more typically less than 80° C., more typically less than 70° C.

Any suitable catalyst ink may be used. The catalyst ink typically comprises polymer electrolyte material, which may or may not be the same polymer electrolyte material which comprises the ICM. The polymer electrolyte is typically an acid-functional fluoropolymer, such as Nafion® (DuPont Chemicals, Wilmington Del.) and Flemion™ (Asahi Glass Co. Ltd., Tokyo, Japan). The polymer electrolytes useful in the present invention are typically preferably copolymers of tetrafluoroethylene and one or more fluorinated, acid-functional comonomers. Typically the polymer electrolyte bears sulfonate functional groups. Most typically the polymer electrolyte is Nafion®. The polymer electrolyte typically has an equivalent weight of 1200 or less, more typically 1100 or less, more typically 1050 or less, and most typically about 1000. The catalyst ink typically comprises a dispersion of catalyst particles in a dispersion of the polymer electrolyte. Any suitable catalyst particles can be used. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. The ink typically contains 5-30% solids (i.e. polymer and catalyst) and more typically 10-20% solids. The electrolyte dispersion is typically an aqueous dispersion, which may additionally contain alcohols and polyalcohols such a glycerin and ethylene glycol. The water, alcohol, and polyalcohol content may be adjusted to alter Theological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency. In a method according to the present invention, the polymer electrolyte material of the ink may be used in the decal process in its acidified form, i.e., without conversion to a salt, and at low temperature, i.e., less than 120° C., more typically less than 100° C., more typically less than 90° C., more typically less than 80° C., more typically less than 70° C.

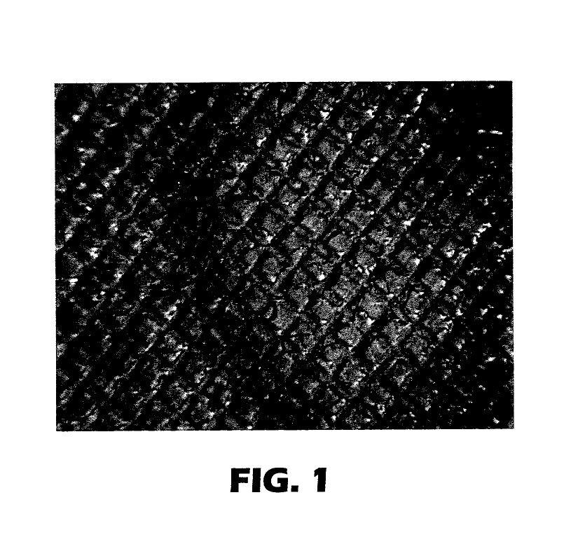

Any suitable transfer medium may be used. In a method according to the present invention, a microstructured transfer medium is used. The microstructured transfer medium includes microfeatures typically having a width (i.e., a smallest dimension in the XY plane between two non-connecting feature edges) of less than 800 μm, more typically less than 600 μm, more typically less than 400 μm, and more typically less than 200 μm. The microfeatures typically have a depth of less than 500 μm, more typically less than 200 μm, more typically less than 100 gm, and more typically less than 60 μm. FIG. 1 typifies the pattern created by one such microstructured transfer medium. The microfeatures have a depth of about 50 μm and the microfeatured pattern has repeating units of 500 μm×500 μm square. Microstructured transfer mediums for use in the practice of the present invention can be made according to any suitable patterning method, including molding pressing, and the like.

In a method according to the present invention, a roughened transfer medium such as a flame-treated silicone-surface transfer medium is used. Flame-treated silicone-surface transfer mediums for use in the practice of the present invention can be made according to the methods described in U.S. Pat. No. 5,900,317. In this method, a surface of a polymeric substrate is modified by exposing the surface to a flame that is supported by a fuel and oxidizer mixture that may or may not include at least one silicone-containing compound. The silicone-containing compound functions as a fuel substitute, but also functions to modify the surface of the polymeric substrate. The amount needed to effect a desired surface modification can range from less than 1 molar percent to 100 molar percent, where “molar percent” is equal to 100 times the molar flow of the compound to the flame divided by the sum of the molar flow of the compound and the molar flow of the fuel.

The catalyst ink may be applied to the transfer medium by any suitable means, including both hand and machine methods, including hand brushing, notch bar coating, fluid bearing die coating, wire-wound rod coating, fluid bearing coating, slot-fed knife coating, and three-roll coating. Coating may be achieved in one pass or in multiple passes.

Transfer of the catalyst ink decal to the ICM may be accomplished by any suitable means, including batchwise and continuous means. Typically, the ICM is overlaid with a catalyst coated transfer medium or sandwiched between two catalyst coated transfer mediums and heat and pressure are applied for a given duration. The transfer medium is then peeled away, leaving catalyst adhering to the ICM. In a method according to the present invention, the pressing step occurs at low temperature, i.e., less than 120° C., more typically less than 100° C., more typically less than 90° C., more typically less than 80° C., more typically less than 70° C.

This invention is useful in making membrane electrode assemblies for use in fuel cells.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all chemicals and reagents were obtained or may be available from Aldrich Chemical Co., Milwaukee, Wis..

### Example 1

### Comparative

A TBA⁺ Ink was prepared as follows: 2.0 g of 10% Nafion® (1000 ew) solution were measured out in a small vial with a small stir rod. To make a 5:2 ink (5:2 catalyst to Nafion) 0.5 g of 40% Pt/C were added to the vial and the contents stirred for one hour. 1.0 g of glycerol as added to the vial and the contents were stirred for 0.5 h. 0.2 g of 1M TBAOH was added using a micropipet and the mixture was stirred for one hour. 1.0 g of additional glycerol was added and the mixture was stirred overnight. Any lumps were ground with a stir rod stirred until no lumps or graininess remained.

A Nafion-H⁺ membrane was converted to Nafion-Na⁺ membrane as follows: A Nafion® 112 membrane was boiled in 1% NaOH for 1 hour and rinsed well in deionized water, then boiled in deionized water for 1 hour.

A 3-Layer MEA was then prepared as follows: A Teflon blank was cleaned with isopropyl alcohol and dried at 140° C. for 10 mins. The Teflon blank was sprayed with Teflon spray and allowed to dry at room temperature for 10 mins. A layer of catalyst ink was brushed on the Teflon blank, brushing in one direction only. The catalyst coated Teflon blank was dried at 140° C. The Nafion® 112 membrane, converted to sodium form, was dried at 130° C. for 5 mins on a vacuum hot plate. A hot press was preheated to 200° C. The membrane was sandwiched between two catalyst coated Teflon blanks and two thin metal sheets were added to both sides of the sandwich. The assembly was centered in the hot press and pressed at 0.86 MPa. The temperature was increased to 210° C. and the pressure increased to 5.18 MPa. After 5 minutes, the pressure was released and the Teflon blanks were peeled off the 3-layer MEA. To convert the Nafion® back to acid form, the MEA was boiled in H₂SO₄ for 2 hours, then rinsed well in deionized water and dried at 60° C. for 20 minutes on a vacuum hot plate.

### Example 2

### Present Invention

An H⁺ Ink was prepared as follows: 125.0 g of 10% Nafion® SE10172 (1100 ew) solution was measured out into a 500 mL glass bottle with Teflon cap and a stir rod. To make a standard 5:2 ink (5:2 catalyst to Nafion), 25.0 g of 40% Pt/C was added to the bottle. A high-shear homogenizer was used for 5 mins to form the ink. A 3-layer MEA was prepared as follows: A microstructured release paper was cleaned and coated with a layer of the H+ink via meyer rod coating. The release paper was a silicone-coated microstructured polypropylene release liner having microfeatures with a depth of about 50 μm. The microfeatured pattern has repeating units of 500 μm×500 μm square. (This release liner is commercially available, e.g. as the release liner of press-in-place emblem adhesive 3M product number 051135-08069 (3M, St. Paul, Minn.)). The coated release paper was allowed to dry at ambient temperature. A Nafion® 112 membrane (purchased from DuPont, Wilmington, Del.) was sandwiched between two pieces of catalyst coated microstructured release paper. The assembly was sandwiched between two polyimide sheets, and two thin stainless steel sheets. The assembly was centered in a hot press and pressed at 66° C. under a pressure of 5.18 MPa for 3 minutes. The assembly was removed from the press and the release papers were removed from the 3-layer MEA, which required no further ion exchange.

### Example 3

### Fuel Cell Performance Evaluation

The ion conducting membrane used in the experiments was Nafion™ 112 membrane (purchased from DuPont, Wilmington, Del.). The GDLs used in these experiments comprised of a Toray paper coated with a carbon/Teflon layer. A 5-Layer MEA was generally prepared as follows: A 50 cm² square piece of the GDL was positioned on each side of a 3-layer MEA, and the assembly was centered in a 50 cm² square hole, cut to match the catalyst area, of a 200 micrometers thick Teflon™ coated fiberglass gasket. A 50 micrometer thick, 15 cm×15 cm sheet of polyimide was placed on each side. This assembly was then placed between two steel shim plates and pressed at 130° C. and a pressure of 21 MPa (0.15 tons per square inch) using a Carver lab press. The polyimide sheets were then peeled away leaving the five-layer MEA.

A Five-layer MEA was mounted in a test cell station (Fuel Cell Technologies, Inc., Albuquerque, N.M.). The test station includes a variable electronic load with separate anode and cathode gas handling systems to control gas flow, pressure and humidity. The electronic load and gas flow are computer controlled. Fuel cell polarization curves were obtained under the following test parameters: electrode area, 50 cm²; cell temperature, 70° C., anode gas pressure of 0 psig; anode gas flow rate at 800 standard cc/min; anode humidification temperature at 75° C.; cathode gas pressure 0 psig; cathode flow rate at 1800 standard cc/min; cathode humidification temperature, 60° C. Humidification of the anode and cathode gas streams was provided by passing the gas through sparge bottles maintained at the stated temperatures. Each fuel cell was brought to operating conditions at 70° C. under hydrogen and air flows. Test protocols were initiated after 12 hours of operation and the following variables were measured: anode pressure, anode flow, cathode pressure, cathode flow, and cell temperature.

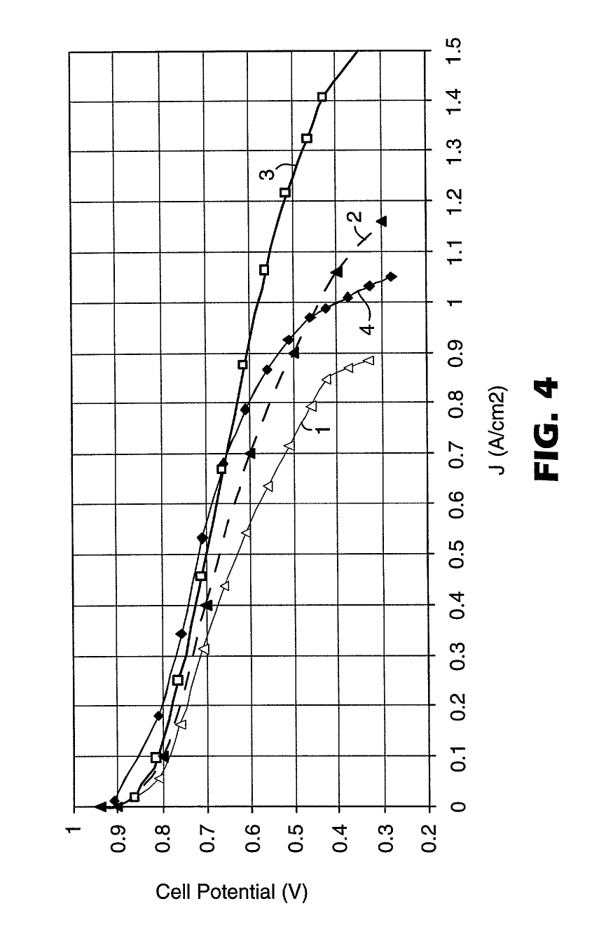

FIG. 4 demonstrates polarization curves for four MEAs: Curve 1 is a comparative MEA made according to Example 1 having a loading of 0.20 mg Pt/cm². Curves 2-4 are MEAs made according to the present invention as disclosed in Example 2, having loadings of 0.11 mg Pt/cm² for curve 2, 0.17 mg Pt/cm² for curve 3, and 0.35 mg Pt/cm² for curve 3.

### Example 4

### Comparison of Release Liners

Table I demonstrates the results obtained in a number of decal application runs made to compare various combinations of: three release liners, including one comparative release liner, six catalyst ink formulations, and three sets of pressing conditions.

Three release liners were compared:

“Gloss” was a comparative release liner with a smooth surface. The release liner was 3M PM6292 Polycoat Kraft Paper liner (3M, St. Paul, Minn.), which is PEK sheet with a glossy silicone coating.

“Flame” was a flame treated release liner, which was the “Gloss” line treated according to the methods described in U.S. Pat. No. 5,900,317 using a ribbon burner at various speed 60 mpm with fuel lean flame composition.

“Micro” is silicone-coated microstructured polypropylene release liner having microfeatures with a depth of about 50 μm. The microfeatured pattern has repeating units of 500 μm×500 μm square. This release liner is commercially available, e.g. as the release liner of press-in-place emblem adhesive 3M product number 051135-08069 (3M, St. Paul, Minn.).

Three sets of transfer conditions were compared: Process ID X: 127° C., 7.78 MPa (77 Atms), 3 mins; Process ID 0: 66° C., 7.78 MPa (77 Atms), 3 mins; Process ID Y: 66° C., 11.7 MPa (116 Atms), 3 mins.

The transfer ratings were assigned according to a visual estimate of the percentage of solids transferred in the decal process, as follows: 5: 100%; 4: ˜90%; 3: ˜70%; 2: ˜40%; 1:<10%.

Loading is based on the weight gain, which includes both anode and cathode loading.

TABLE I

| | | | Solid | Glycerin | Alcohol | Water | Process | Loading | Transfer |
|---|---|---|---|---|---|---|---|---|---|
| Exp. ID | Liner ID | Ink ID | (%) | (%) | (%) | (%) | ID | (mg/cm² ) | Rating |
| 1 | Flame | 1 | 12% | 10% | 41% | 37% | X | 0.45 | 4 |
| 2 | Flame | 2 | 13% | 5% | 43% | 39% | X | 0.27 | 3 |
| 3 | Flame | 3 | 13% | 3% | 44% | 40% | X | 0.33 | 4 |
| 4 | Flame | 4 | 14% | 0% | 45% | 41% | X | 0.38 | 3 |
| 5 | Flame | 5 | 14% | 0% | 0% | 86% | X | 0.29 | 3 |
| 6 | Flame | 6 | 13% | 6% | 0% | 82% | X | 0.27 | 3 |
| 7 | Flame | 1 | 12% | 10% | 41% | 37% | O | 0.37 | 2 |
| 8 | Flame | 2 | 13% | 5% | 43% | 39% | O | 0.18 | 2 |
| 9 | Flame | 3 | 13% | 3% | 44% | 40% | O | N/A | N/A |
| 10 | Flame | 4 | 14% | 0% | 45% | 41% | O | 0.10 | 1 |
| 11 | Flame | 5 | 14% | 0% | 0% | 86% | Y | 0.10 | 2 |
| 12 | Flame | 6 | 13% | 6% | 0% | 82% | Y | 0.17 | 3 |
| 13 | Gloss | 1 | 12% | 10% | 41% | 37% | O | 0.38 | 2 |
| 14 | Gloss | 2 | 13% | 5% | 43% | 39% | O | 0.13 | 2 |
| 15 | Gloss | 3 | 13% | 3% | 44% | 40% | O | N/A | N/A |
| 16 | Gloss | 4 | 14% | 0% | 45% | 41% | O | 0.05 | 1 |
| 17 | Gloss | 5 | 14% | 0% | 0% | 86% | O | 0.09 | 1 |
| 18 | Gloss | 6 | 13% | 6% | 0% | 82% | O | 0.07 | 2 |
| 19 | Gloss | 1 | 12% | 10% | 41% | 37% | Y | 0.44 | 2 |
| 20 | Gloss | 2 | 13% | 5% | 43% | 39% | Y | 0.21 | 2 |
| 21 | Gloss | 3 | 13% | 3% | 44% | 40% | Y | 0.21 | N/A |
| 22 | Gloss | 4 | 14% | 0% | 45% | 41% | Y | 0.11 | 2 |
| 23 | Gloss | 5 | 14% | 0% | 0% | 86% | Y | N/A | N/A |
| 24 | Gloss | 6 | 13% | 6% | 0% | 82% | Y | 0.13 | 2 |
| 25 | Micro | 1 | 12% | 10% | 41% | 37% | X | 0.91 | 4 |
| 26 | Micro | 2 | 13% | 5% | 43% | 39% | X | 0.85 | 5 |
| 27 | Micro | 3 | 13% | 3% | 44% | 40% | X | N/A | N/A |
| 28 | Micro | 4 | 14% | 0% | 45% | 41% | X | N/A | N/A |
| 29 | Micro | 5 | 14% | 0% | 0% | 86% | X | 0.71 | 4 |
| 30 | Micro | 6 | i3% | 6% | 0% | 82% | X | 0.68 | 5 |
| 31 | Micro | 1 | i2% | 10% | 41% | 37% | Y | 1.11 | 5 |
| 32 | Micro | 2 | 13% | 5% | 43% | 39% | Y | N/A | N/A |
| 33 | Micro | 3 | 13% | 3% | 44% | 40% | Y | N/A | 3 |
| 34 | Micro | 4 | 14% | 0% | 45% | 41% | Y | 0.83 | 5 |
| 35 | Micro | 5 | 14% | 0% | 0% | 86% | Y | N/A | N/A |
| 36 | Micro | 6 | 13% | 6% | 0% | 82% | Y | 0.59 | 5 |
| 37 | Micro | 1 | 12% | 10% | 41% | 37% | O | 1.02 | 3 |
| 38 | Micro | 4 | 14% | 0% | 45% | 41% | O | 0.80 | 4 |
| 39 | Micro | 5 | 14% | 0% | 0% | 86% | O | 0.62 | 4 |
| 40 | Micro | 6 | 13% | 6% | 0% | 82% | O | N/A | N/A |
| 41 | Micro | 2 | 13% | 5% | 43% | 39% | O | 0.93 | 5 |
| 42 | Micro | 3 | 13% | 3% | 44% | 40% | O | 0.79 | 5 |

All experiments (exp. 13 to 24) with commercial PEK Silicone Gloss gave very poor transfer efficiency. Generally less than 50% of catalyst Decal was transferred to the ICM, even at high temperature (127° C.). Experiments with flame treated release liner afforded higher transfer efficiency. Under appropriate conditions, more than 90% of catalyst Decals were transferred (see, exp. 1 and 3). With microstructured release liner, all experiments showed higher than 90% of catalyst transfer efficiency. Under appropriated conditions, even at low process temperature (66° C., see exp. 26, 30, 31, 34, 36, 41, 42), perfect transfers were obtained. In addition, very high catalyst loading could be obtained via one single transfer.

Without wishing to be bound by theory, it is believed that the high transfer efficiency from the flame treated release liner can be attributed to a good match of its release properties with the properties of ink #1 and ink #3. The microstructured release liner afforded a much higher transfer efficiency for a broad spectra of inks and transfer conditions. Presumably, this is due to the confinement of catalyst layers into the microstructures. During the Decal transfer, release liners with low release force tend to cause coherent failure and therefore poor transfer is obtained. Release liners with high release force are usually not printable by inks. The formation of mud cracks prevents the formation of good catalyst Decal layers. Use of the microstructured release liner allows an easier coating of catalyst ink on a surface with very low bonding force. After drying, the mud cracks are confined within the microstructures.

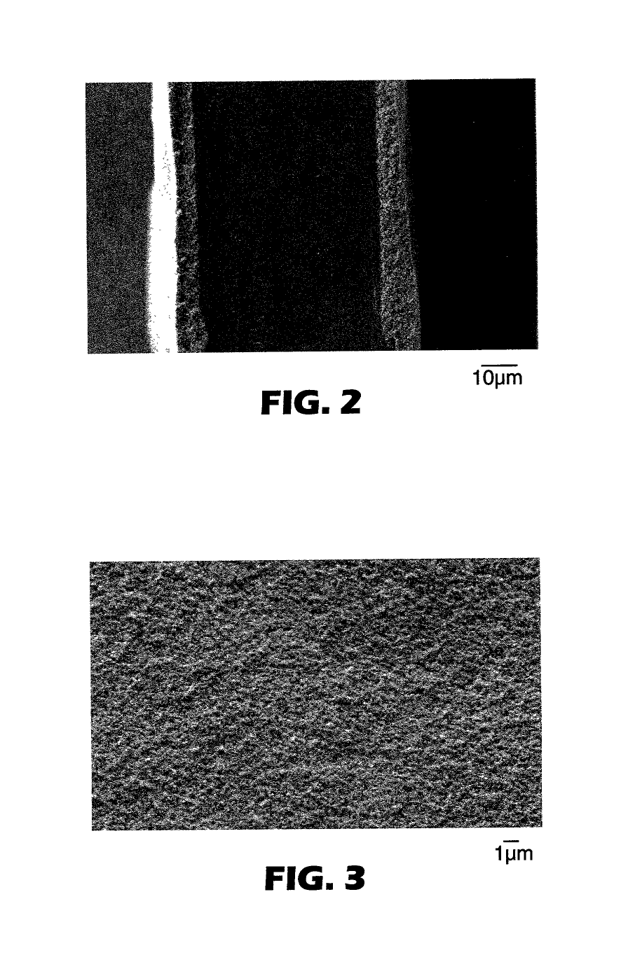

FIG. 1 is an optical micrograph of a 3-Layer MEA prepared by use of the MTSD microstructured release liner. The pattern comprises “plateaus” separated by “canals”. The microstructure features are 500 μm×500 μm. One can clearly see that the mud cracks of catalyst Decal are confined by the microstructures. FIG. 2 shows a SEM cross-section picture of the above 3-Layer MEA. FIG. 3 shows a SEM surface picture of the above MEA. Very smooth and porous catalyst surface was obtained.

Various modifications and alterations of this invention will become apparent to those skilled in the art without departing from the scope and principles of this invention, and it should be understood that this invention is not to be unduly limited to the illustrative embodiments set forth hereinabove. All publications and patents are herein incorporated by reference to the same extent as if each individual publication or patent was specifically and individually indicated to be incorporated by reference.

We claim:

1. A method of making a membrane electrode assembly comprising the step of decal transfer of a catalyst ink to a surface of an ion conducting membrane, wherein said ion conducting membrane is in an acidified form, wherein said step of decal transfer occurs at a temperature of less than 120° C.

2. A method of making a membrane electrode assembly comprising the step of decal transfer of a catalyst ink to a surface of an ion conducting membrane, wherein said step of decal transfer occurs at a temperature of less than 120° C.

3. A method according to claim 2 wherein said step of decal transfer occurs at a temperature of less than 100° C.

4. A method according to claim 2 wherein said step of decal transfer occurs at a temperature of less than 90° C.

5. A method according to claim 2 wherein said step of decal transfer occurs at a temperature of less than 80° C.

6. A method according to claim 2 wherein said step of decal transfer occurs at a temperature of less than 70° C.

7. A method according to claim 1 wherein said step of decal transfer occurs at a temperature of less than 120° C.

8. A method according to claim 1 wherein said step of decal transfer occurs at a temperature of less than 100° C.

9. A method according to claim 1 wherein said step of decal transfer occurs at a temperature of less than 90° C.

10. A method according to claim 1 wherein said step of decal transfer occurs at a temperature of less than 80° C.

11. A method according to claim 1 wherein said step of decal transfer occurs at a temperature of less than 70° C.

12. A method of making a membrane electrode assembly comprising the step of decal transfer of a catalyst ink to a surface of an ion conducting membrane, wherein said catalyst ink is transferred from a microstructured transfer medium.

13. A method of making a membrane electrode assembly comprising the step of decal transfer of a catalyst ink to a surface of an ion conducting membrane, wherein said catalyst ink is transferred from a flame-treated silicone-containing transfer medium.

14. A membrane electrode assembly made according to the method of claim 1.

15. A membrane electrode assembly made according to the method of claim 2.

16. A membrane electrode assembly made according to the method of claim 12.

17. A membrane electrode assembly made according to the method of claim 13.

18. A method according to claim 12 wherein said step of de cal transfer occurs at a temperature of less than 120° C.

19. A method according to claim 13 wherein said step of decal transfer occurs at a temperature of less than 120° C.

20. A method according to claim 12 wherein said step of decal transfer occurs at a temperature of less than 70° C.

21. A method according to claim 13 wherein said step of decal transfer occurs at a temperature of less than 70° C.

22. A method according to claim 12 wherein said wherein said ion conducting membrane is in an acidified form.

23. A method according to claim 13 wherein said wherein said ion conducting membrane is in an acidified form.

24. A method according to claim 18 wherein said wherein said ion conducting membrane is in an acidified form.

25. A method according to claim 19 wherein said wherein said ion conducting membrane is in an acidified form.

26. A method according to claim 20 wherein said wherein said ion conducting membrane is in an acidified form.

27. A method according to claim 21 wherein said wherein said ion conducting membrane is in an acidified form.

28. A membrane electrode assembly made according to the method of claim 26.

29. A membrane electrode assembly made according to the method of claim 27.

30. A method of making a membrane electrode assembly comprising the step of decal transfer of a catalyst ink to a surface of an ion conducting membrane, wherein said catalsyt ink comprises polymer electrolyte in an acidified form, wherein said step of decal transfer occurs at a temperature of less than 120° C.

31. A method according to claim 30 wherein said step of decal transfer occurs at a temperature of less than 100° C.

32. A method according to claim 30 wherein said step of decal transfer occurs at a temperature of less than 90° C.

33. A method according to claim 30 wherein said step of decal transfer occurs at a temperature of less than 80° C.

34. A method according to claim 30 wherein said step of decal transfer occurs at a temperature of less than 70° C.

35. A method according to claim 30 wherein said catalyst ink is transferred from a microstructured transfer medium.

36. A method according to claim 30 wherein said catalyst ink is transferred from a flame-treated silicone-containing transfer medium.
